(19) United States
(12) Patent Application Publication
(10) Pub. No.: US 2014/0160785 A1
(43) Pub. Date: Jun. 12, 2014

(54) LIGHT GUIDING SYSTEM AND CEILING STRUCTURE

(71) Applicant: CHI LIN TECHNOLOGY CO., LTD., Tainan City (TW)

(72) Inventors: JUNG-LIEH TSAI, TAINAN CITY (TW); YI-HSING CHIANG, TAINAN CITY (TW)

(73) Assignee: CHI LIN TECHNOLOGY CO., LTD., Tainan City (TW)

(21) Appl. No.: 14/094,317

(22) Filed: Dec. 2, 2013

(30) Foreign Application Priority Data
Dec. 6, 2012 (TW) 101145779

(51) Int. Cl. F21S 8/04

(52) U.S. Cl. CPC F21S 8/046
USPC 362/576

(57) ABSTRACT

The present invention relates to a light guiding system and a ceiling structure. The light guiding system includes a first light guiding element and a second light guiding element disposed on a first plane and a second plane of a accommodation space, respectively. The second light guiding element includes a plurality of light guiding structures, each having a first surface and a second surface. The light beam from the first light guiding element is refracted by the first surface to enter the light guiding structure, then reflected, and then refracted by the second surface to emit out.

### BACKGROUND OF THE INVENTION

1. Field of the Invention

The present invention relates to a light guiding system and a ceiling structure, and more particularly to a light guiding system and a ceiling structure capable of changing the direction of incident light.

2. Description of the Related Art

The conventional light guiding device is of various types, for example, a flat panel, a shutter or a film, which is located on or near a window of a room, used for guiding the sunlight beams outside the room into the room. The sunlight beams are directed to illuminate the ceiling in the room. Then, the sunlight beams are reflected by the ceiling, to enter the interior of the room more deep, and used as indoor lighting or auxiliary lighting. In addition, in some conventional light guiding devices, the sunlight beams can be directly horizontally guided into the room without being reflected by the ceiling.

Although the conventional light guiding device could guide the light deep into the room, illumination of the desk in the room cannot be effectively improved as the light cannot directly irradiate on the desk. Thus, use of the conventional light guiding device in the daytime cannot effectively save the energy used by other lighting devices.

Therefore, it is necessary to provide a light guiding system and a ceiling structure so as to solve the above problem.

### SUMMARY OF THE INVENTION

The present invention provides a light guiding system, including a first light guiding element and a second light guiding element. The first light guiding element is disposed on a first plane of a accommodation space. The second light guiding element is disposed in a second plane of the accommodation space, where the first plane and the second plane are not the same plane, a plurality of first light beams becomes a plurality of second light beams after passing through the first light guiding element, to enter the accommodation space, part of the second light beams are guided to the second light guiding element, the second light guiding element includes a plurality of light guiding structures, each light guiding structure is a light-transmissible material, and has a first surface and a second surface, part of the second light beams from the first light guiding element enters the light guiding structure after being refracted by the first surface to become a plurality of third light beams, and part of the third light beams are emitted out after being refracted by the second surface.

Thereby, a plurality of first light beams becomes a plurality of second light beams after passing through the first light guiding element, to enter the accommodation space. Part of the second light beams becomes a plurality of fourth light beams and a plurality of fifth light beams after passing through the light guiding structures. The fourth light beams and the fifth light beams can directly irradiate to the desk in the accommodation space in a near-vertical manner, so as to effectively improve illumination of the desk. Therefore, use of the light guiding system in the daytime can effectively save the energy used by other lighting devices.

### BRIEF DESCRIPTION OF THE DRAWINGS

FIG. 1 shows a schematic view of an embodiment of a light guiding system according to the present invention;

FIG. 2 shows a schematic perspective view of an embodiment of a first light guiding element according to the present invention;

FIG. 3 shows a side view of the first light guiding element in FIG. 2;

FIG. 4 shows a partially enlarged view of FIG. 3;

FIG. 5 shows a partially schematic side view of an embodiment of a second light guiding element according to the present invention;

FIG. 6 shows a partially schematic side view of another embodiment of the second light guiding element according to the present invention;

FIG. 7 shows a partially schematic side view of another embodiment of the second light guiding element according to the present invention;

FIG. 8 shows a partially schematic side view of another embodiment of the second light guiding element according to the present invention;

FIG. 9 shows a partially schematic side view of another embodiment of the second light guiding element according to the present invention; and

FIG. 10 shows a partially schematic side view of another embodiment of the second light guiding element according to the present invention.

### PREFERRED EMBODIMENT OF THE PRESENT INVENTION

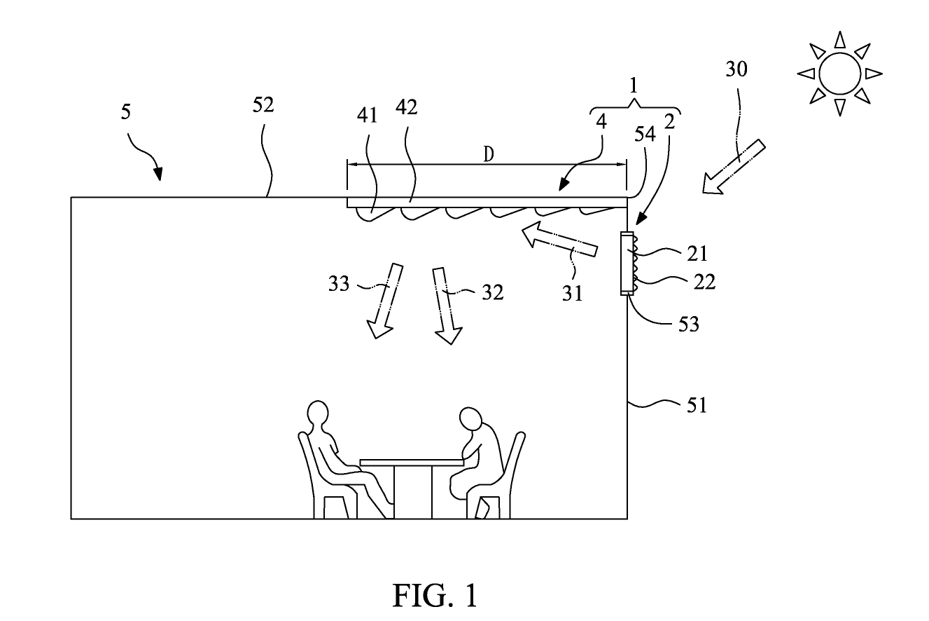

FIG. 1 shows a schematic view of an embodiment of a light guiding system according to the present invention. The light guiding system 1 includes a first light guiding element 2 and a second light guiding element 4. In this embodiment, the first light guiding element 2 and the second light guiding element 4 are both disposed in a accommodation space 5 (for example, a room), and the accommodation space 5 has a first plane 51 and a second plane 52. The first plane 51 is a side wall, and a plurality of first light beams 30 (for example, the sunlight beams) irradiates on the first plane 51; the second plane 52 is the ceiling, and the first plane 51 is substantially perpendicular to the second plane 52. That is, the first plane 51 and the second plane 52 are not the same plane.

The first light guiding element 2 is disposed on the first plane 51 of the accommodation space 5. The first light beams 30 become a plurality of second light beams 31 after passing through the first light guiding element 2, to enter the interior of the accommodation space 5. Preferably, the light guiding system 1 further includes a transparent structure 53 (for example, a window), which is disposed on the first plane 51 of the accommodation space 5. The first light guiding element 2 is disposed on the transparent structure 53.

The second light guiding element 4 is disposed on the second plane 52 of the accommodation space 5. Part of the second light beams 31 are guided to the second light guiding element 4, and the second light guiding element 4 includes a plurality of light guiding structures 41 and a base body 42. The light guiding structures 41 are located on the base body 42, and each light guiding structure 41 is a light-transmissible material. In this embodiment, the first plane 51 and the second plane 52 have an intersection line 54, and a distance D between the light guiding structures 41 and the intersection line 54 is less than 3 meters.

Part of the second light beams 31 from the first light guiding element 2 becomes a plurality of fourth light beams 32 and a plurality of fifth light beams 33 after passing through the light guiding structures 41, wherein the fourth light beams 32 and the fifth light beams 33 can directly irradiate to the desk in the accommodation space 5 (for example, a room) in a near-vertical manner, so as to effectively improve illumination of the desk. Therefore, use of the light guiding system 1 in the daytime can effectively save the energy used by other lighting devices.

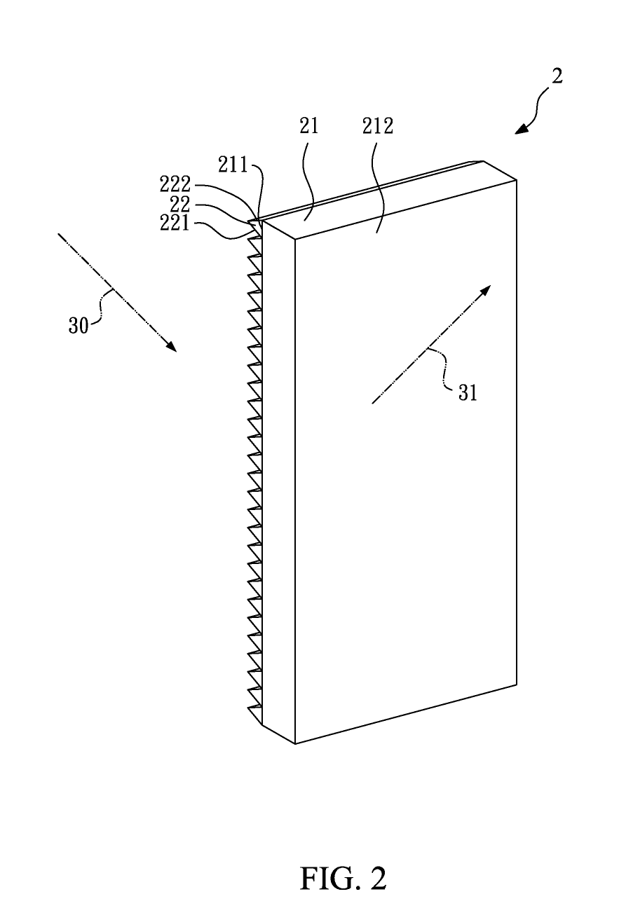

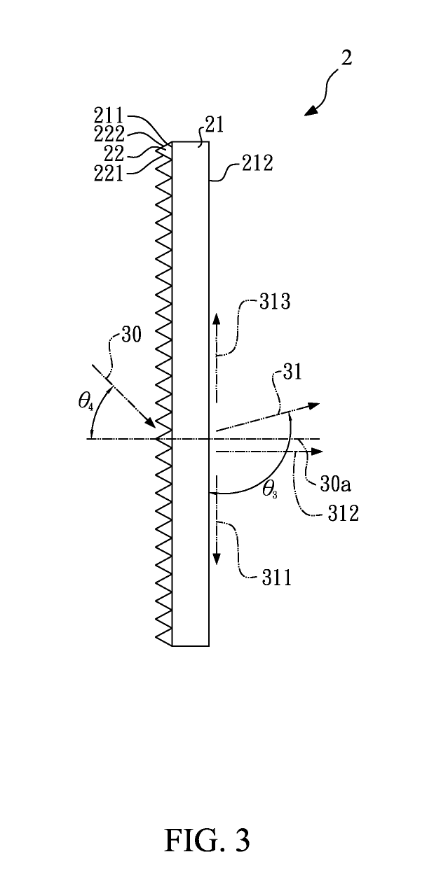

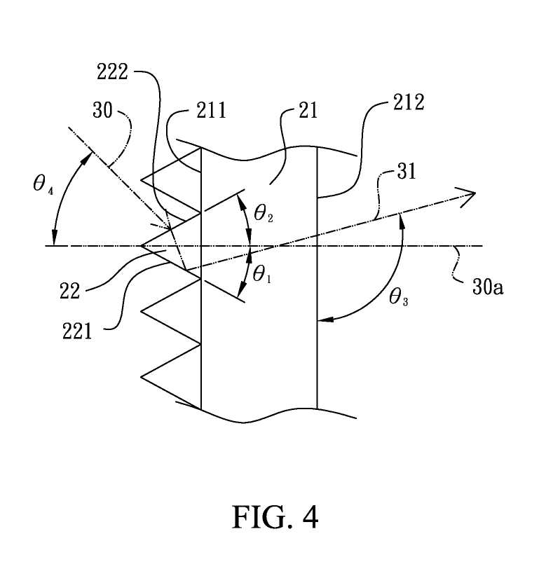

Referring to FIG. 2 to FIG. 4, FIG. 2 shows a schematic perspective view of an embodiment of a first light guiding element according to the present invention, FIG. 3 shows a side view of the first light guiding element in FIG. 2, and FIG. 4 shows a partially enlarged view of FIG. 3. The first light guiding element 2 is a light guiding film, and comprises a film base 21 and at least one microstructure 22. In this embodiment, the first light guiding element 2 includes a plurality of microstructures 22. The film base 21 has a first side 211 and a second side 212, and the second side 212 is opposite to the first side 211.

The microstructure 22 is located on the first side 211 or the second side 212 of the film base 21, and the microstructure 22 includes a first surface 221 and a second surface 222. The second surface 222 is above the first surface 221. In this embodiment, the cross section of the microstructure 22 is substantially triangular, and the first surface 221 intersects with the second surface 222.

A reference plane 30a is defined as an phantom plane that is perpendicular to the first side 211 or the second side 212 of the film base 21. That is, when the light guiding film 2 stands upright, the reference plane 30a is a phantom horizontal plane. A first inclination angle θ₁ (FIG. 4) is between the first surface 221 and the reference plane 30a, and a second inclination angle θ₂ (FIG. 4) is between the second surface 222 and the reference plane 30a, wherein the first inclination angle θ₁ is less than or equal to the second inclination angle θ₂.

As shown in FIG. 4, in this embodiment, the value of the first inclination angle θ₁ is between 11 degrees and 19 degrees, the value of the second inclination angle θ₂ is between 52 degrees and 68 degrees, and a sum of the first inclination angle θ₁ and the second inclination angle θ₂ is between 63 degrees and 87 degrees. Preferably, the value of the first inclination angle θ₁ is 15 degrees, and the value of the second inclination angle θ₂ is 60 degrees.

The material of the film base 21 may be different from that of the microstructure 22. The film base 21 is made of a light-transmissible material, for example, Polymethyl Methacrylate (PMMA), Arcylic-based Polymer, Polycarbonate (PC), Polyethylene Terephthalate (PET), Polystyrene (PS) or a copolymer thereof, with a refractive index of 1.35 to 1.65.

The microstructure 22 is made of a light-transmissible metal oxide, such as TiO₂ or Ta₂O₅, with a refractive index of 1.9 to 2.6. In an embodiment, one layer of the metal oxide is formed on the film base 21 firstly. Then, the microstructure 22 is formed by means of etching It should be understood that, the material of the film base 21 may be the same as that of the microstructure 22.

In this embodiment, the first light beams 30 (for example, the sunlight beams) become the second light beams 31 after passing through the first light guiding element 2. As shown in FIG. 3, an angle between the second light beams 31 and the first light guiding element 2 is defined as an output angle θ₃. When the second light beam (that is, the light beam 311) is downward and parallel to the first light guiding element 2, the output angle θ₃ is defined as 0 degree. When the second light beam (that is, the light beam 312) is horizontal and parallel to the reference plane 30a, the output angle θ₃ is defined as 90 degrees. When the second light beam (that is, the light beam 313) is upward and parallel to the first light guiding element 2, the output angle θ₃ is defined as 180 degrees.

An angle between the incident light beam 30 and the reference plane 30a is defined as an incident angle θ₄. When the incident light beam 30 is downward, the incident angle θ₄ is defined as a positive value. When the incident light beam (not shown) is horizontal and parallel to the reference plane 30a, the incident angle θ₄ is defined as 0 degree, and when the incident light beam (not shown) is upward, the incident angle θ₄ is defined as a negative value.

As shown in FIG. 4, the first light beam 30 enters the microstructure 22 from the second surface 222 of the microstructure 22 through refraction, and is reflected by the first surface 221 of the microstructure 22. Then, the reflected first light beam 30 becomes the second light beam 31 after passing through the film base 21. Due to the special design of the first inclination angle θ₁ and the second inclination angle θ₂, the first light beam 30 is reflected by the first surface 221. Therefore, when the incident angle θ₄ of the first light beams 30 is between 30 and 60 degrees and downward, more than 50% of the second light beams 31 are upward. In addition, the second light beams 31 will concentrate in a specific range of the output angle θ₃, that is, the total luminous flux of the second light beams 31 in the specific range of the output angle is a peak value with respect to other second light beams 31 in other ranges of the output angle.

In this embodiment, the incident angle θ₄ of the first light beams 30 is between 30 and 60 degrees, and the total luminous flux of the second light beams 31 with the output angle between 85 degrees and 120 degrees is greater than 40% of the total luminous flux of the second light beams 31 with the output angle between 0 degree and 180 degrees.

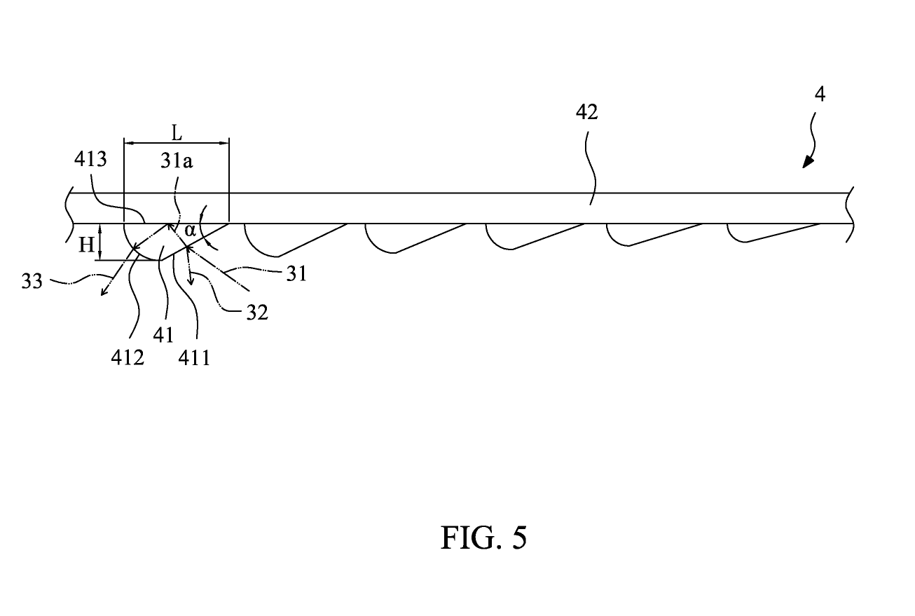

FIG. 5 shows a partially schematic side view of an embodiment of a second light guiding element according to the present invention. The second light guiding element 4 includes a plurality of light guiding structures 41 and a base body 42, and the light guiding structures 41 are located on the base body 42. The cross section of the light guiding structure 41 is substantially sectorial, triangular or polygonal. Each light guiding structure 41 has a first surface 411, a second surface 412 and a reflection surface 413. In this embodiment, the first surface 411 is a plane, facing the second light beams 31; the second surface 412 is a curved surface, and the cross section of each light guiding structure 41 is substantially sectorial. The reflection surface 413 is an interface connecting the base body 42, used for reflecting light beams from the first surface 411 to the second surface 412.

The material of the base body 42 is the same as that of the light guiding structures 41, i.e., they are all made of light-transmissible materials, for example, Polymethyl Methacrylate (PMMA), Arcylic-based Polymer, Polycarbonate (PC), Polyethylene Terephthalate (PET), Polystyrene (PS) or a copolymer thereof, with a refractive index of 1.35 to 1.65. It should be understood that, the material of the base body 42 may be different from that of the light guiding structures 41.

Each light guiding structure 41 has a length L and a height H, the length L is between 10 μm and 2000 μm, and the height H is between 10 μm and 1000 μm. An inclination angle between the first surface 411 of each light guiding structure 41 and the second plane 52 of the accommodation space 5 (or the base body 42) is defined as a structural angle α. In this embodiment, different light guiding structures 41 have different structural angles a, and have different heights H. In other embodiments, the second light guiding element 4 can be divided into a plurality of distribution areas, wherein the light guiding structures 41 located in the same distribution area have the same structural angle α, while the light guiding structures 41 located in different distribution areas have different structural angles α.

In actual use, part of the second light beams 31 from the first light guiding element 2 become a plurality of third light beams 31a after being refracted by the first surface 411 to enter the light guiding structure 41 (it should be noted that, at this time, part of the second light beams 31 may be reflected by the first surface 411 to become the fourth light beams 32), and part of the third light beams 31a is reflected by the reflection surface 413 to the second surface 412, and refracted by the second surface 412 to emit out to become the fifth light beams 33.

In this embodiment, the light guiding structures 41 are located on the base body 42. However, in other embodiments, the base body 42 may be omitted, and thus the light guiding structures 41 are directly located on the second surface 52 of the accommodation space 5, to form a ceiling structure.

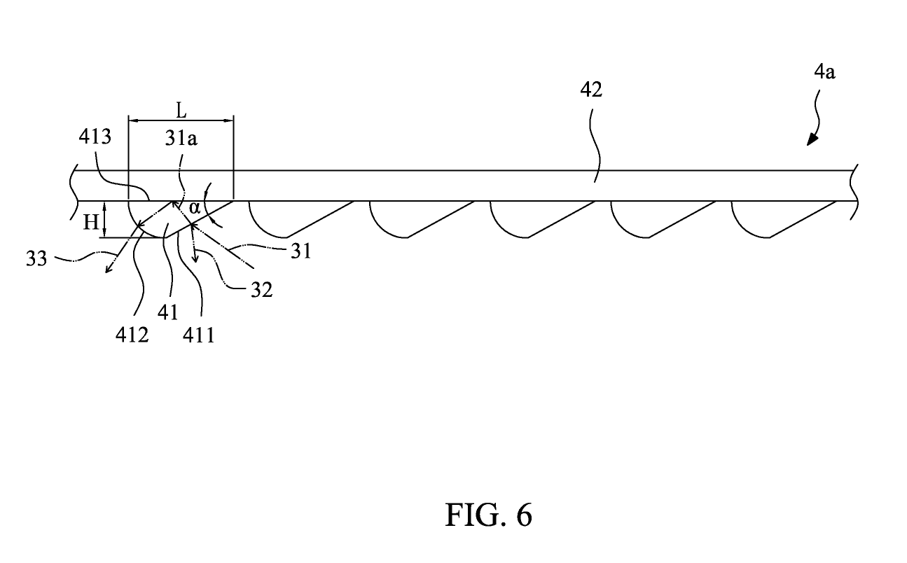

FIG. 6 shows a partially schematic side view of another embodiment of the second light guiding element according to the present invention. The second light guiding element 4a in this embodiment is substantially similar with the second light guiding element 4 shown in FIG. 5, wherein the same elements are assigned with the same numeral. The difference between the second light guiding element 4a in this embodiment and the second light guiding element 4 shown in FIG. 5 lies in that, in this embodiment, all the light guiding structures 41 have the same structural angle α, and have the same length L and height H.

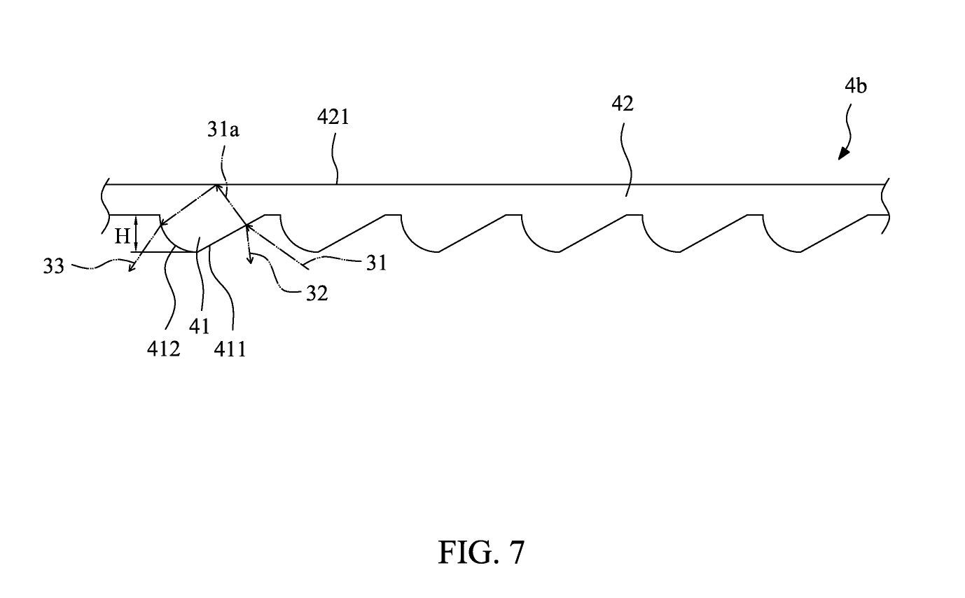

FIG. 7 shows a partially schematic side view of another embodiment of the second light guiding element according to the present invention. The second light guiding element 4b in this embodiment is substantially similar with the second light guiding element 4 shown in FIG. 5, wherein the same elements are assigned with the same numeral. The difference between the second light guiding element 4b in this embodiment and the second light guiding element 4 shown in FIG. 5 lies in that, in this embodiment, the light guiding structures 41 and the base body 42 are integrally formed. Thus, an upper surface 421 of the base body 42 is a reflection surface.

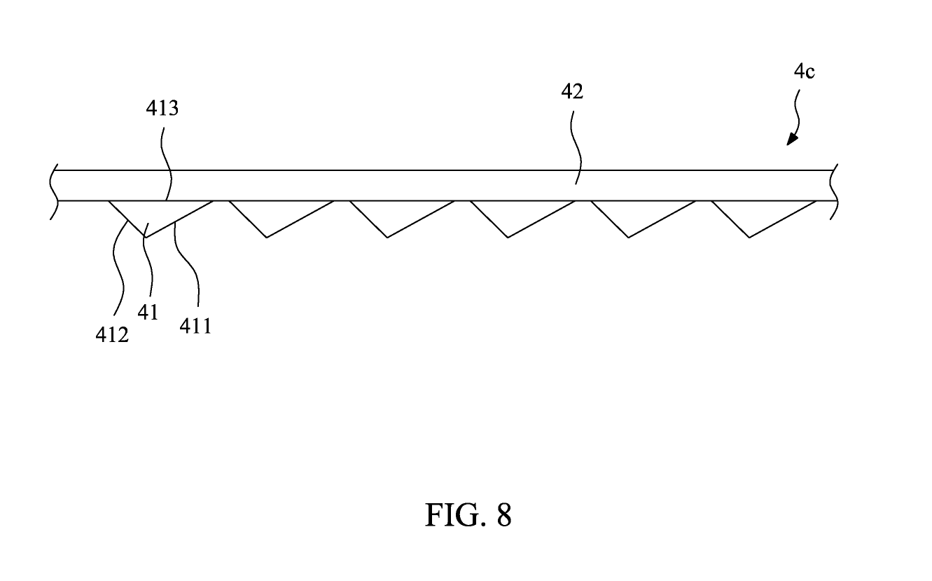

FIG. 8 shows a partially schematic side view of another embodiment of the second light guiding element according to the present invention. The second light guiding element 4c in this embodiment is substantially similar with the second light guiding element 4a shown in FIG. 6, wherein the same elements are assigned with the same numeral. The difference between the second light guiding element 4c in this embodiment and the second light guiding element 4a shown in FIG. 6 lies in that, in this embodiment, the second surface 412 of the light guiding structure 41 is a plane.

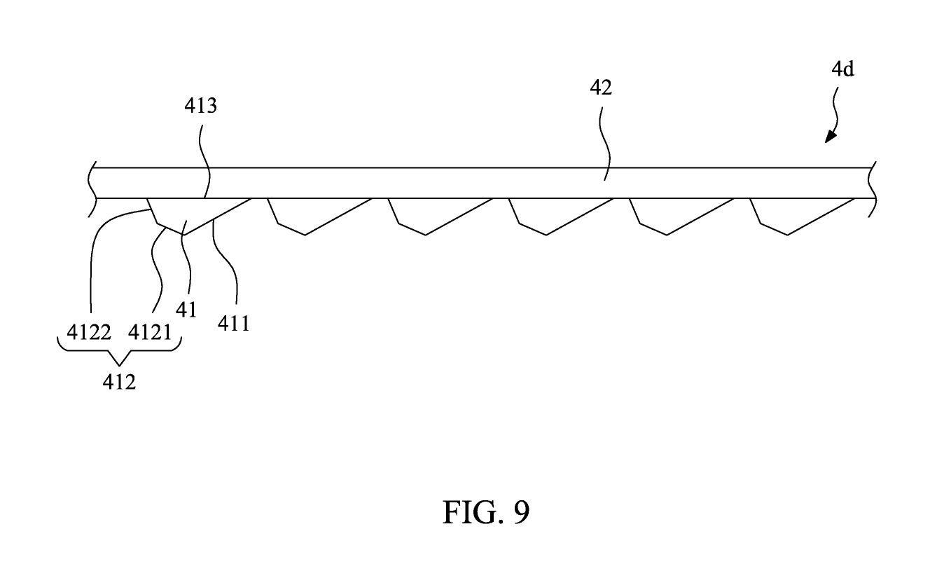

FIG. 9 shows a partially schematic side view of another embodiment of the second light guiding element according to the present invention. The second light guiding element 4d in this embodiment is substantially similar with the second light guiding element 4a shown in FIG. 6, wherein the same elements are assigned with the same numeral. The difference between the second light guiding element 4d in this embodiment and the second light guiding element 4a shown in FIG. 6 lies in that, in this embodiment, the second surface 412 of the light guiding structure 41 consists of a first slant surface 4121 and a second slant surface 4122.

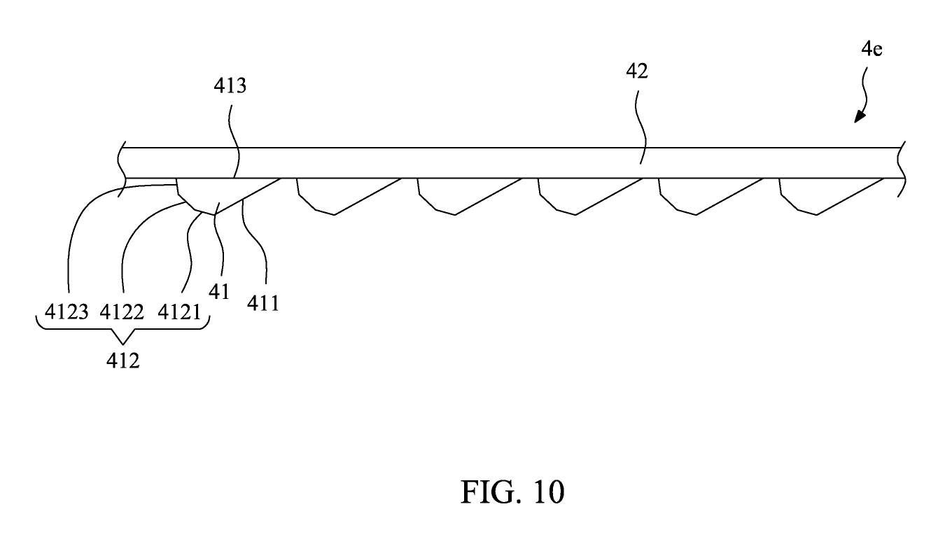

FIG. 10 shows a partially schematic side view of another embodiment of the second light guiding element according to the present invention. The second light guiding element 4e in this embodiment is substantially similar with the second light guiding element 4a shown in FIG. 6, wherein the same elements are assigned with the same numeral. The difference between the second light guiding element 4e in this embodiment and the second light guiding element 4a shown in FIG. 6 lies in that, in this embodiment, the second surface 412 of the light guiding structure 41 consists of a first slant surface 4121, a second slant surface 4122 and a third slant surface 4123.

The above embodiments merely describe the principle and effects of the present invention, but not intended to limit the present invention. Therefore, modifications and variations made by persons skilled in the art to the embodiments without departing from the spirit of the present invention should fall within the scope of the present invention as defined by the appended claims.

What is claimed is:

1. A light guiding system, comprising:
a first light guiding element, disposed on a first plane of a accommodation space; and
a second light guiding element, disposed on a second plane of the accommodation space, wherein the first plane and the second plane are not the same plane, a plurality of first light beams becomes a plurality of second light beams after passing through the first light guiding element, to enter the accommodation space, part of the second light beams are guided to the second light guiding element, the second light guiding element includes a plurality of light guiding structures, each light guiding structure is a light-transmissible material, and has a first surface and a second surface, part of the second light beams from the first light guiding element enters the light guiding structure and becomes a plurality of third light beams after being refracted by the first surface, and part of the third light beams are emitted out after being refracted by the second surface.

2. The light guiding system according to claim 1, wherein the light guiding system further includes a third surface, used for reflecting part of the third light beams to the second surface.

3. The light guiding system according to claim 1, wherein the first light guiding element includes:
a film base, having a first side and a second side, the second side being opposite to the first side; and
at least one microstructure, located on the first side or the second side of the film base, a cross section of the microstructure being substantially triangular.

4. The light guiding system according to claim 1, wherein the accommodation space is a room, the first plane is a side wall of the room, and the second plane is the ceiling of the room.

5. The light guiding system according to claim 4, wherein the first light beams are the sunlight beams.

6. The light guiding system according to claim 1, further comprising a transparent structure, disposed on the first plane of the accommodation space, wherein the first light guiding element is disposed on the transparent structure.

7. The light guiding system according to claim 1, wherein the second light guiding element further includes a base body, and the light guiding structures are located on the base body.

8. The light guiding system according to claim 7, wherein the light guiding structures and the base body are integrally formed.

9. The light guiding system according to claim 1, wherein the second light guiding element further includes a reflection surface, used for reflecting light beams from the first surface of the light guiding structure to the second surface of the light guiding structure.

10. The light guiding system according to claim 1, wherein a cross section of the light guiding structure is substantially sectorial, triangular or polygonal.

11. The light guiding system according to claim 1, wherein an inclination angle between the first surface of the light guiding structure and the second plane of the accommodation space is defined as a structural angle, and the light guiding structures have different structural angles.

12. The light guiding system according to claim 1, wherein an inclination angle between the first surface of the light guiding structure and the second plane of the accommodation space is defined as a structural angle, the second light guiding element is divided into a plurality of distribution areas, and the light guiding structures located in different distribution areas have different structural angles.

13. The light guiding system according to claim 1, wherein the first plane and the second plane have an intersection line, and a distance between the light guiding structures and the intersection line is less than 3 meters.

14. The light guiding system according to claim 1, wherein each light guiding structure has a length and a height, the length is between 10 μm and 2000 μm, and the height is between 10 μm and 1000 μm.

15. A ceiling structure, comprising:
a plurality of light guiding structures, each of the light guiding structures being a light-transmissible material, and having a first surface and a second surface, the first surface facing a plurality of light beams, part of the light beams entering the light guiding structure after being refracted by the first surface, and emitting out after being refracted by the second surface.
